(19) United States
(12) Patent Application Publication
(10) Pub. No.: US 2026/0067595 A1
(43) Pub. Date: Mar. 5, 2026

(54) IMAGE SENSOR SYSTEM

(71) Applicant: Samsung Electronics Co., Ltd., Suwon-si (KR)

(72) Inventors: Won Seok LEE, Suwon-si (KR); Jung Chan KYOUNG, Suwon-si (KR); Young Jin KIM, Suwon-si (KR); Young Il SEO, Suwon-si (KR)

(21) Appl. No.: 19/269,337

(22) Filed: Jul. 15, 2025

(30) Foreign Application Priority Data
Aug. 30, 2024 (KR) 10-2024-0117757

(51) Int. Cl. H04N 25/78; H04N 25/767

(52) U.S. Cl. CPC H04N 25/78; H04N 25/767

(57) ABSTRACT

An image sensor system comprising an image sensor including a pixel array converting a received optical signal into an electrical signal and a readout circuit that converts the electrical signal into image data and outputs the image data, a memory storing a plurality of weights used for processing the image data, a processor selecting one of the plurality of weights and providing a control signal generated by the selected weight to an image signal processor (ISP) included in the image sensor system. The ISP which includes, a page table including a plurality of register tables used for processing the image data, a selection register outputting a second signal that selects a register table corresponding to the selected weight from among the plurality of register tables, in response to the control signal and a core processing the image data based on the selected weight and the register table corresponding to the selected weight.

### CROSS-REFERENCE TO RELATED APPLICATION

This application claims priority from Korean Patent Application No. 10-2024-0117757 filed on Aug. 30, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to an image sensor system.

### 2. Description of the Related Art

An image capturing device is used to capture a user-intended image, including an object and a background. The image capturing device includes various electronic circuits for collecting light and generating signals related to the image, providing the service of capturing an image to the user according to the operations of the electronic circuits. Meanwhile, image capturing devices are widely distributed and used by many users. Accordingly, it has become necessary to meet the various user requirements regarding the performance and functionality of image capturing devices. For example, to increase user satisfaction, it may be required to enhance the processing performance of image capturing devices while miniaturizing them. Additionally, to reduce the power consumed by image capturing devices, it may be required to appropriately control the operating mode of image capturing devices. In this manner, methods for improving the structure and operation of image capturing devices have been proposed to meet the diverse needs of users.

### SUMMARY

Aspects of the present disclosure provide a miniaturized and directly integrated image sensor system.

Aspects of the present disclosure also provide an image sensor system with reduced power consumption.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided an image sensor system comprising an image sensor including a pixel array converting a received optical signal into an electrical signal and a readout circuit that converts the electrical signal into image data and outputs the image data, a memory storing a plurality of weights used for processing the image data, a processor selecting one of the plurality of weights and providing a control signal generated by the selected weight to an image signal processor (ISP) and the ISP which includes, a page table including a plurality of register tables used for processing the image data, a selection register outputting a second signal that selects a register table corresponding to the selected weight from among the plurality of register tables, in response to the control signal and a core processing the image data based on the selected weight and the register table corresponding to the selected weight.

According to the aforementioned and other embodiments of the present disclosure, an image sensor system comprising an image sensor including a pixel array converting a received optical signal into an electrical signal and a readout circuit that converts the electrical signal into image data and outputs the image data, a processor selecting a training model to be used for processing the image data and providing a control signal generated by the selected training model to an image signal processor (ISP), a selection register outputting a second signal that controls the selection of a register table corresponding to the selected training model, in response to the control signal, a weight selection register outputting a fourth signal that controls the selection of a weight corresponding to the selected training model, in response to the control signal, a page table storing a plurality of register tables and selecting and outputting one of the plurality of register tables based on the second signal, a weight table storing a plurality of weights and selecting and outputting one of the plurality of weights based on the fourth signal and the ISP including a core that processes the image data based on the selected weight and the register table corresponding to the selected weight.

According to the aforementioned and other embodiments of the present disclosure, an image sensor system comprising an image sensor including a pixel array converting a received optical signal into an electrical signal and a readout circuit that converts the electrical signal into image data and outputs the image data, a memory storing a plurality of weights used for processing the image data, a processor selecting a first weight from among the plurality of weights and providing a first control signal generated by the first weight to an image signal processor (ISP), a page table including a plurality of register tables used for processing the image data, a selection register outputting a first selection signal that selects a first register table corresponding to the first weight from among the plurality of register tables, in response to the first control signal, an image signal processor (ISP) including a core that processes the image data based on the first weight received from the memory and the first register table received from the page table, wherein the page table includes a multiplexer that selects and outputs the first register table from among the plurality of register tables in response to the first selection signal, and the core performs a first operation of calculating a weighted sum of the image data based on the first weight, and performs a second operation of adding nonlinearity to the weighted sum based on the first register table.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram illustrating an image sensor system according to some embodiments of the present disclosure.

FIG. 2 is a block diagram illustrating some of the components in FIG. 1.

FIG. 3 is a block diagram illustrating the memory of FIG. 1.

FIG. 4 is a block diagram illustrating the configuration and operation of an image signal processor according to some embodiments of the present disclosure.

FIG. 5 is a block diagram illustrating data in a memory and data in a page table according to some embodiments of the present disclosure.

FIGS. 6 through 10 are diagrams illustrating the configuration and operation of an ISP according to some embodiments of the present disclosure.

FIGS. 11 through 14 are diagrams illustrating the configuration and operation of an ISP according to some embodiments of the present disclosure.

FIGS. 15 and 16 are block diagrams illustrating the configuration and operation of ISPs according to some embodiments of the present disclosure.

FIGS. 17 through 22 are diagrams illustrating the configuration and operation of an ISP according to some embodiments of the present disclosure.

FIGS. 23 through 25 are block diagrams illustrating the configuration and operation of an ISP according to some embodiments of the present disclosure.

FIGS. 26 and 27 are block diagrams illustrating the configuration and operation of ISPs according to some embodiments of the present disclosure.

### DETAILED DESCRIPTION

Embodiments of the present disclosure will hereinafter be described in detail with reference to the accompanying drawings. Identical reference numerals are used for identical components in the drawings, and thus, redundant descriptions thereof will be omitted.

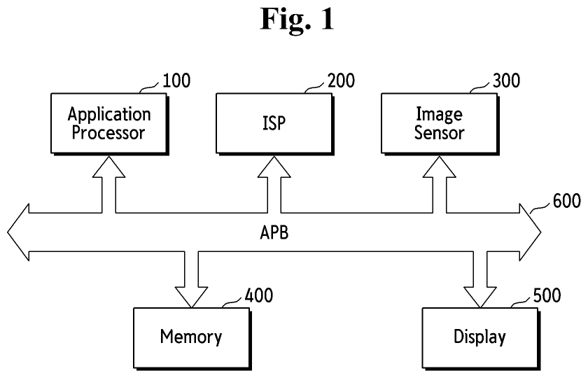

FIG. 1 is a block diagram illustrating an image sensor system according to some embodiments of the present disclosure.

Referring to FIG. 1, the image signal system may be a portable terminal. The image signal system may include an application processor 100, an image signal processor (ISP) 200, an image sensor 300, a memory 400, a display device 500, and a system bus interface (i.e., Advanced Peripheral Bus (APB)) 600.

The application processor 100 controls the overall operation of the image signal system and may be implemented as a system-on-chip (SoC) that drives applications, operating systems, etc. The application processor 100 may provide image data supplied from the ISP 200 to the display device 500. In some embodiments, the ISP 200 may include image processing circuitry and perform image processing such as image quality adjustment and data format conversion on the image data received from the image sensor 300.

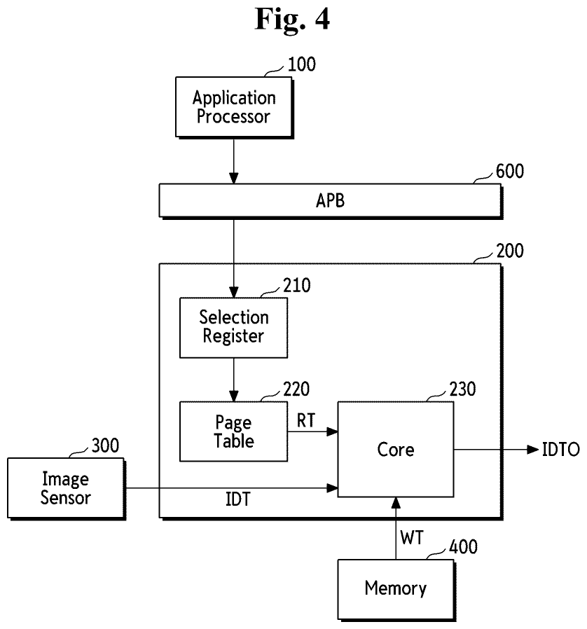

The ISP 200 may be the same as an ISP 200 that will be described later with reference to FIG. 4. The ISP 200 may select various training data (i.e., weights and page tables corresponding to the weights) that correspond to various patterns in the generated image data and perform deep learning-based image processing based on the selected training data.

The memory 400 may be implemented as a volatile memory such as a dynamic random-access memory (DRAM) or static-random access memory (SRAM), or as a non-volatile resistive memory such as a ferroelectric random-access memory (FeRAM), resistive random-access memory (RRAM), or phase-change random-access memory (PRAM). The memory 400 may store programs and/or data that are processed or executed by the application processor 100.

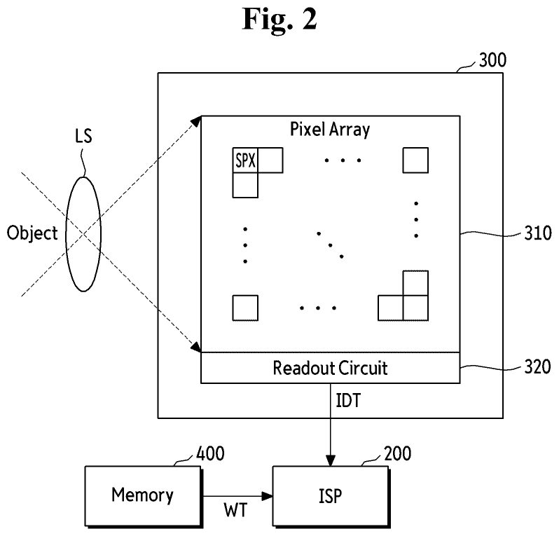

FIG. 2 is a block diagram illustrating some of the components in FIG. 1.

Referring to FIG. 2, the image sensor 300 may convert the optical signal of an object incident through an optical lens LS into image data. The image sensor 300 may be mounted on an electronic device with image or optical sensing functionality. For example, the image sensor 300 may be mounted on an electronic device such as a digital still camera, a digital video camera, a smartphone, a wearable device, an Internet of Things (IoT) device, a tablet PC, a PDA, a portable multimedia player, or a navigation device. Furthermore, the image sensor 300 may be mounted on an electronic device provided as a component in vehicles, furniture, manufacturing equipment, doors, various measurement devices.

The image sensor 300 may include a pixel array 310 and a readout circuit 320. The readout circuit 320 may provide image data IDT to the ISP 200.

The ISP 200 may include deep learning-based processing logic. In some embodiments, the pixel array 310, the readout circuit 320, and the ISP 200 may be implemented as a single semiconductor chip or semiconductor module. Alternatively, in some embodiments, the pixel array 310 and the readout circuit 320 may be implemented as one semiconductor chip, while the ISP 200 may be implemented as a separate semiconductor chip.

The pixel array 310 may be implemented as a photoelectric conversion element, such as a charge-coupled device (CCD) or complementary metal oxide semiconductor (CMOS) device. The pixel array 310 includes a plurality of pixels that convert received optical signals (i.e., light) into electrical signals, and the pixels may be arranged in a matrix. Each of the pixels may include a light-detecting element. For example, the light-detecting element may include a photodiode, phototransistor, photogate, or pinned photodiode. The readout circuit 320 may convert electrical signals received from the pixel array 310 into image data IDT. The readout circuit 320 may amplify the electrical signals and perform analog-to-digital conversion on the amplified electrical signals. The image data IDT generated by the readout circuit 320 may include pixel data corresponding to each of the pixels of the pixel array 310.

The ISP 200 may perform deep learning-based image processing on the image data IDT output from the readout circuit 320. For example, the ISP 200 may include a deep learning bad pixel corrector (DLBPC), and may perform image processing such as bad pixel correction and noise reduction on the image data IDT utilizing the DLBPC.

The ISP 200 may perform deep learning-based image processing on the image data IDT based on a weight WT output from the memory 400. The ISP 200 may output the image-processed image data. The image-processed image data may be provided to the application processor 100 (e.g., the main processor or graphics processor of the electronic device where the image sensor 300 is mounted).

The ISP 200 may include deep learning-based processing logic. In some embodiments, the processing logic may be implemented as hardware, but is not limited thereto. Alternatively, the processing logic may be implemented as software or a combination of hardware and software. The processing logic may perform deep learning-based image processing on the image data IDT based on the weight WT output from the memory 400.

In some embodiments, the ISP 200 may process the image data IDT using a particular weight for the operating model of the image sensor 300 and a corresponding register table. The operating model of the image sensor 300 may be determined according to user settings, i.e., the settings used by the user of the electronic device where the image sensor 300 is mounted, or may be determined based on the sensing environment (or sensing settings) when the image sensor 300 senses the optical signal of an object.

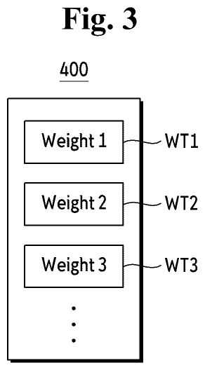

FIG. 3 is a block diagram illustrating the memory of FIG. 1.

Referring to FIG. 3, the memory 400 may include a plurality of weights used by the ISP 200 for processing the image data IDT. In this specification, the term “weight” may refer to a set of weights used by the ISP 200 to process the image data IDT. Weights (e.g., values, coefficients) control the influence that input data has on output data within a neural network. A set of weights of a neural network encapsulates what the network has learned from training data, thereby encoding the knowledge necessary for providing a relevant output.

In some embodiments, the memory 400 may include a plurality of weights. For example, the memory 400 may include a first weight WT1, a second weight WT2, and a third weight WT3. However, the present disclosure is not limited to this example, and the memory 400 may include three or more sets of weights.

For example, the first weight WT1 may be used by the ISP 200 to process the image data IDT when operating in the mode of a first training model Model1. The second weight WT2 may be used by the ISP 200 to process the image data IDT when operating in the mode of a second training model Model2. The third weight WT3 may be used by the ISP 200 to process the image data IDT when operating in the mode of a third training model Model3.

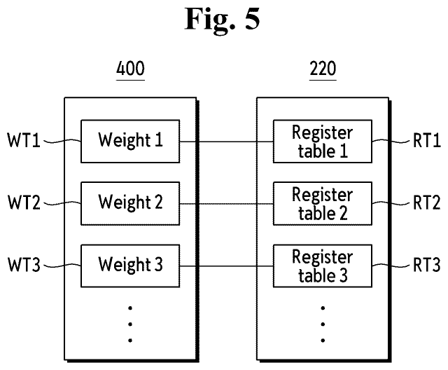

FIG. 4 is a block diagram illustrating the configuration and operation of an image signal processor according to some embodiments of the present disclosure. FIG. 5 is a block diagram illustrating data in a memory and data in a page table according to some embodiments of the present disclosure.

Referring to FIGS. 4 and 5, an ISP 200 may include a plurality of image signal processing logics. For convenience of description, only one image signal processing logic (i.e., ISP 200) is illustrated in FIG. 4 as being included in the ISP 200. The ISP 200 may include a selection register 210, a page table 220, and a core 230, and the selection register 210, the page table 220, and the core 230 may constitute a deep learning-based processing logic.

The ISP 200 may process image data IDT based on a plurality of training models. The training models may process the image data IDT based on corresponding pairs of weights WT and register tables RT. Here, the weights WT may adjust the importance of the image data IDT when the image data IDT is transmitted to each neuron in a neural network. For example, the weights WT may each form a linear combination with the image data IDT for each neuron. The register tables RT may be tables storing parameters as constant values to be applicable to the linear combinations of the weights WT and the image data IDT. In some embodiments, the parameters may add nonlinearity to the linear combinations of an input value and the weights WT. For example, a first training model Model1 may process the image data IDT based on a first weight WT1 and a first register table RT1, a second training model Model2 may process the image data IDT based on a second weight WT2 and a second register table RT2, and a third training model Model3 may process the image data IDT based on a third weight WT3 and a third register table RT3.

The selection register 210 may be implemented as a special function register (SFR) and may generate a signal for selecting one of a plurality of register tables RT stored in the page table 220. The page table 220 may store the register tables RT and may select and transmit one of the register tables RT to the core 230. The image data IDT may be provided to the core 230 from the image sensor 300. Under the command of the application processor 100, one of the weights WT stored in a memory 400 may be provided to the core 230. Under the command of the application processor 100, one of the register tables RT stored in the page table 220 may be provided to the core 230. The core 230 within the ISP 200 may process the image data IDT based on the weight WT provided thereto and the corresponding register table RT. The image data IDT processed by the core 230, i.e., image data IDTO, may be provided to the application processor 100 (e.g., the main processor or graphics processor of the electronic device where the image sensor 300 is mounted).

By storing the parameters corresponding to the respective weights WT in advance in table form withing the page table 220 and selecting one of the stored register tables RT based on each selected weight WT, the total number of a special function register (SFR) can be effectively minimized compared to a approach in which SFR is assigned for each parameter. As a result, the number of register circuits can be reduced, and the complexity of the address decoding logic required for accessing the registers can also be lowered, thereby contributing to a reduction in the overall chip area of the image sensor system. Accordingly, the size of the electronic device including the ISP 200 can be reduced.

Only the first, second, and third weights WT1, WT2, and WT3 and the first, second, and third register tables RT1, RT2, and RT3 are shown in the drawings, but the embodiments of the present disclosure are not limited thereto. Alternatively, the image sensor system according to some embodiments of the present disclosure may include three or more weights and their respective register tables.

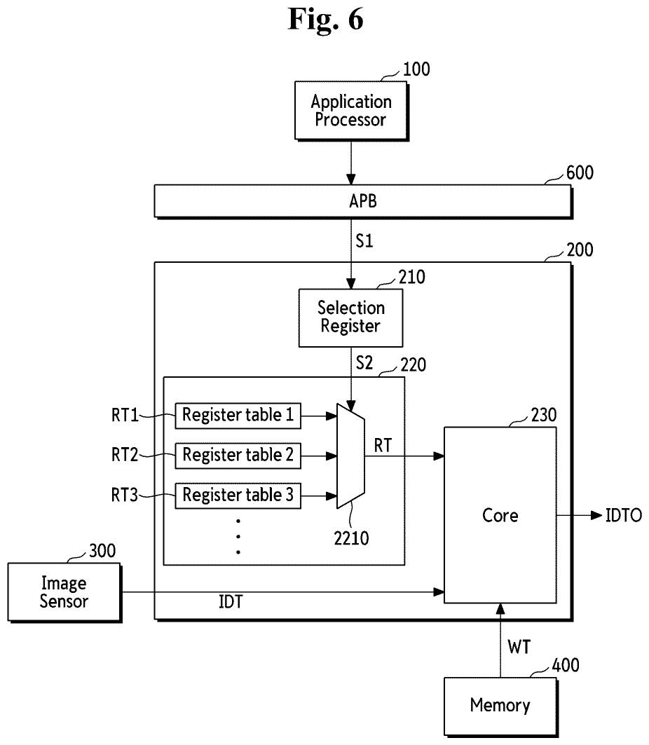

FIGS. 6 through 10 are diagrams illustrating the configuration and operation of an ISP according to some embodiments of the present disclosure.

Referring to FIG. 6, image data IDT, a weight WT, and a register table RT may be provided to a core 230 based on each training model. In some embodiments, the image data IDT may be provided from an image sensor 300. Under the command of an application processor 100, the weight WT stored in a memory 400 may be provided to the core 230. The application processor 100 may select the weight WT to be used for processing the image data IDT and may transmit a first signal S1 to a selection register 210. The first signal S1 may be a signal generated based on the selected weight WT. The selection register 210 may generate a second signal S2 based on the first signal S1 and may transmit the second signal S2 to a page table 220.

The page table 220 may include a plurality of register tables RT and a first multiplexer 2210. Each of the plurality of register tables RT may be an input signal for the first multiplexer 2210, and the second signal S2 may be a control signal for the first multiplexer 2210. The first multiplexer 2210 may select a register table RT corresponding to the second signal S2 from among the plurality of register tables RT and may transmit the selected register table RT to the core 230. The output signal of the page table 220 may be the register table RT corresponding to the selected weight WT.

The core 230 within the ISP 200 may process the image data IDT based on the selected weight WT and the selected register table RT corresponding to the selected weight WT. The image data IDT processed by the core 230, i.e., image data IDTO, may be provided to the application processor 100 (e.g., the main processor or graphics processor of the electronic device where the image sensor 300 is mounted).

By storing the parameters corresponding to the respective weights WT in advance in table form withing the page table 220 and selecting one of the stored register tables RT based on each selected weight WT, the total number of a special function register (SFR) can be effectively minimized compared to a approach in which SFR is assigned for each parameter. As a result, the number of register circuits can be reduced, and the complexity of the address decoding logic required for accessing the registers can also be lowered, thereby contributing to a reduction in the overall chip area of the image sensor system. Accordingly, miniaturization of the electronic device including the ISP 200 can be achieved.

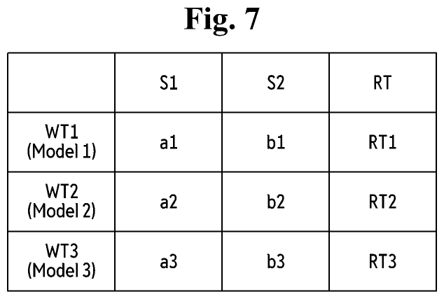

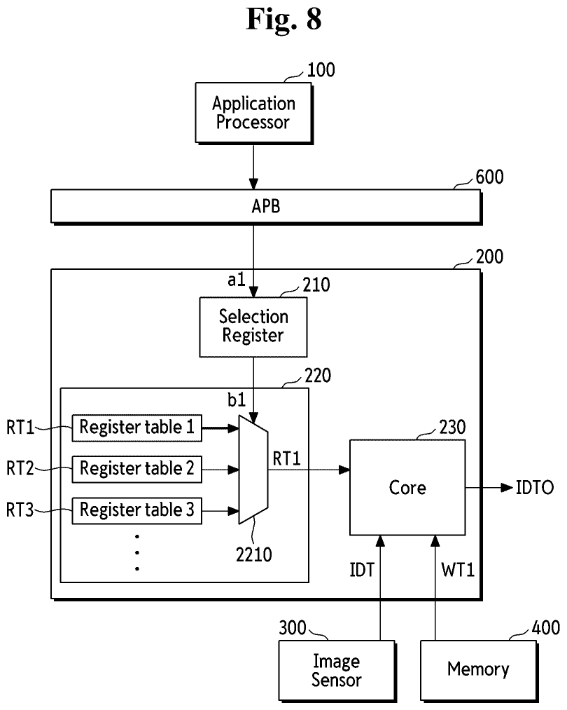

Referring to FIGS. 7 and 8, as the application processor 100 selects a first training model Model1 that uses a first weight WT1 to process the image data IDT, a first register table RT1 corresponding to the first weight WT1 may be selected within the ISP 200.

The application processor 100 may transmit a first control signal a1 to the selection register 210 to select the first register table RT1 corresponding to the first weight WT1 for use in the first training model Model1. The selection register 210 may generate a first selection signal b1 based on the first control signal a1 and may transmit the first selection signal b1 to the page table 220. The first multiplexer 2210 included in the page table 220 may select the first register table RT1 from among a plurality of register tables RT based on the first selection signal b1 and may transmit the first register table RT1 to a core 230.

The image data IDT may be provided from the image sensor 300. Under the command of the application processor 100, the first weight WT1 stored in the memory 400 may be provided to the core 230. The core 230 within the ISP 200 may process the image data IDT based on the first weight WT1 and the first register table RT1 corresponding to the first weight WT1. The image data IDT processed by the core 230, i.e., image data IDTO, may be provided to the application processor 100 (e.g., the main processor or graphics processor of the electronic device where the image sensor 300 is mounted).

By storing parameters corresponding to respective weights in advance in table form within the page table 220 and selecting one of the stored register tables based on each selected weight WT, the required area can be minimized compared to implementing the parameters as SFRs. Accordingly, miniaturization of the electronic device including the ISP 200 can be achieved.

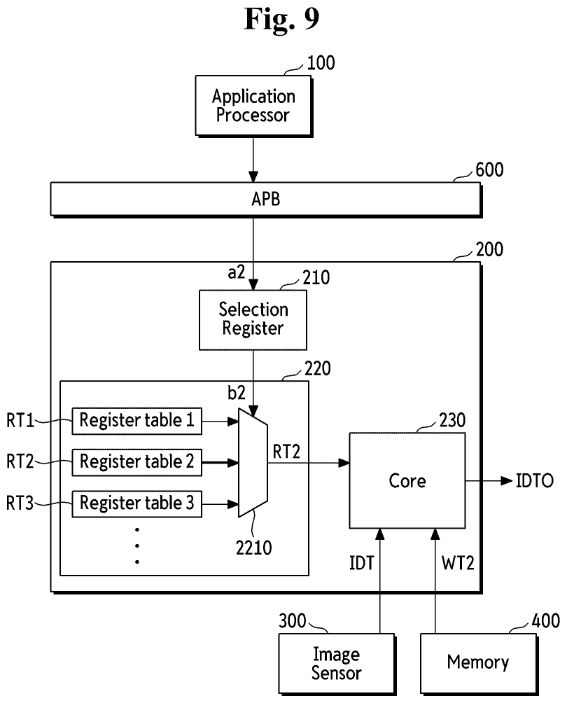

Referring to FIGS. 7 and 9, as the application processor 100 selects a second training model Model2 that uses a second weight WT2 to process the image data IDT, a second register table RT2 corresponding to the second weight WT2 may be selected within the ISP 200.

Specifically, the application processor 100 may transmit a second control signal a2 to a selection register 210 to select the second register table RT2 corresponding to the second weight WT2 for use in the second training model Model2. The selection register 210 may generate a second selection signal b2 based on the second control signal a2 and may transmit the second selection signal b2 to the page table 220.

The first multiplexer 2210 included in the page table 220 may select the second register table RT2 from among a plurality of register tables RT based on the second selection signal b2 and may transmit the second register table RT2 to the core 230. The image data IDT may be provided from the image sensor 300. Under the command of the application processor 100, the second weight WT2 stored in the memory 400 may be provided to the core 230. The core 230 within the ISP 200 may process the image data IDT based on the second weight WT2 and the second register table RT2 corresponding to the second weight WT2.

The image data IDT processed by the core 230, i.e., image data IDTO, may be provided to the application processor 100 (e.g., the main processor or graphics processor of the electronic device on which the image sensor 300 is mounted).

By storing parameters corresponding to respective weights in advance in table form within the page table 220 and selecting one of the stored register tables based on each selected weight, the required area can be minimized compared to implementing the parameters as SFRs. Accordingly, miniaturization of the electronic device including the ISP 200 can be achieved.

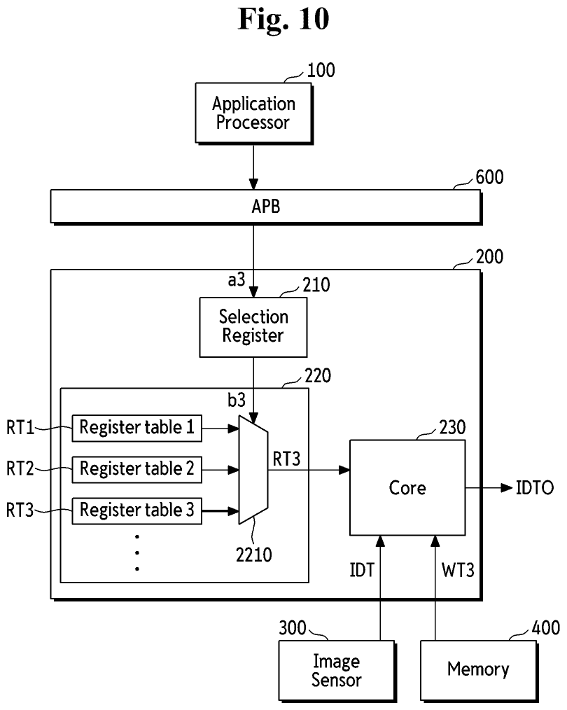

Referring to FIGS. 7 and 10, as the application processor 100 selects a third training model Model3 that uses a third weight WT3 to process the image data IDT, a third register table RT3 corresponding to the third weight WT3 may be selected within the ISP 200. The application processor 100 may transmit a third control signal a3 to a selection register 210 to select the third register table RT3 corresponding to the third weight WT3 for use in the third training model Model3.

The selection register 210 may generate a third selection signal b3 based on the third control signal a3 and may transmit the third selection signal b3 to the page table 220. The first multiplexer 2210 included in the page table 220 may select the third register table RT3 from among a plurality of register tables RT based on the third selection signal b3 and may transmit the third register table RT3 to the core 230. The image data IDT may be provided from the image sensor 300. Under the command of the application processor 100, the third weight WT3 stored in the memory 400 may be provided to the core 230.

The core 230 within the ISP 200 may process the image data IDT based on the third weight WT3 and the third register table RT3 corresponding to the third weight WT3. The image data IDT processed by the core 230, i.e., image data IDTO, may be provided to the application processor 100 (e.g., the main processor or graphics processor of the electronic device where the image sensor 300 is mounted). By storing parameters corresponding to respective weights in advance in table form within the page table 220 and selecting one of the stored register tables based on each selected weight, the required area can be minimized compared to implementing the parameters as SFRs. Accordingly, miniaturization of the electronic device including the ISP 200 can be achieved.

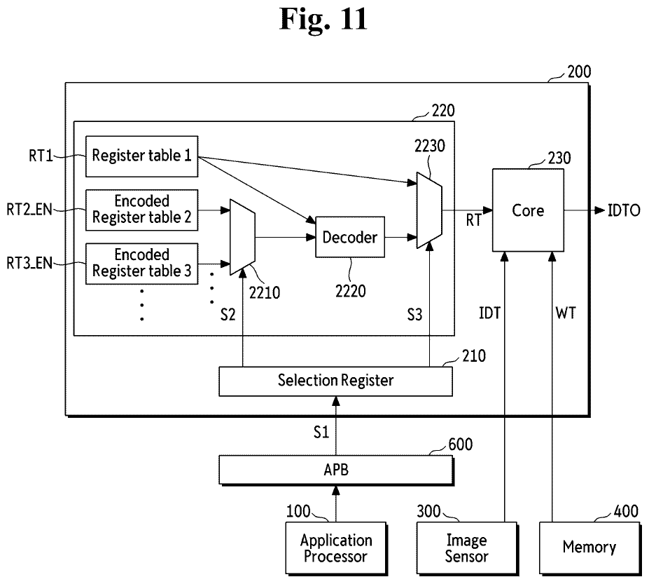

FIGS. 11 through 14 are diagrams illustrating the configuration and operation of an ISP according to some embodiments of the present disclosure.

Referring to FIG. 11, in some embodiments, image data IDT, a weight WT, and a register table RT may be provided to a core 230 based on each training model. In some embodiments, the image data IDT may be provided from an image sensor 300.

Under the command of an application processor 100, the weight WT stored in a memory 400 may be provided to the core 230. The application processor 100 may select the weight WT to be used for processing the image data IDT and may transmit a first signal S1 to a selection register 210. The first signal S1 may be a signal generated based on the selected weight WT. The selection register 210 may generate a second signal S2 and a third signal S3 based on the first signal S1 and may transmit the second signal S2 and the third signal S3 to a page table 220.

The page table 220 may include a plurality of register tables RT, a first multiplexer 2210, a decoder 2220, and a second multiplexer 2230. The plurality of register tables RT may include a first register table RT1, a second encoded register table RT2_EN, and a third encoded register table RT3_EN. The first register table RT1 may be a parameter corresponding to a first weight WT1. The second encoded register table RT2_EN may be an encoded form of a second register table RT2 corresponding to a second weight WT2, which is different from the first weight WT1. The second encoded register table RT2_EN may store the difference values between the first and second register tables RT1 and RT2 in table form. The third encoded register table RT3_EN may be an encoded form of a third register table RT3 corresponding to a third weight WT3, which is different from the first and second weights WT1 and WT2. The third encoded register table RT3_EN may store the difference values between the first and third register tables RT1 and RT3 in table form. The second and third encoded register tables RT2_EN and RT3_EN may be input signals for the first multiplexer 2210, and the second signal S2 may be a control signal for the first multiplexer 2210. The first multiplexer 2210 may select one of the second and third encoded register tables RT2_EN and RT3_EN corresponding to the second signal S2 and may transmit the selected encoded register table RT2_EN or RT3_EN to the decoder 2220.

The decoder 2220 may decode the encoded register table RT2_EN or RT3_EN output from the first multiplexer 2210 based on the first register table RT1, outputting either the second register table RT2 or the third register table RT3. For example, if the second encoded register table RT2_EN is selected by the second signal S2 in the first multiplexer 2210, the decoder 2220 may output the second register table RT2 based on the first register table RT1 and the second encoded register table RT2_EN. Additionally, if the third encoded register table RT3_EN is selected by the second signal S2 in the first multiplexer 2210, the decoder 2220 may output the third register table RT3 based on the first register table RT1 and the third encoded register table RT3_EN. The second register table RT2 or the third register table RT3 output from the decoder 2220 may be transmitted to the second multiplexer 2230.

The second multiplexer 2230 may transmit either the first register table RT1 or the output signal from the decoder 2220 (i.e., the second register table RT2 or the third register table RT3) to the core 230 based on the third signal S3. The output signal of the second multiplexer 2230 may be one of the first, second, and third register tables RT1, RT2, and RT3 corresponding to the selected weight WT. The core 230 within the ISP 200 may process the image data IDT based on the selected weight WT and the selected register table RT corresponding to the selected weight WT. The image data IDT processed by the core 230, i.e., image data IDTO, may be provided to the application processor 100 (e.g., the main processor or graphics processor of the electronic device where the image sensor 300 is mounted).

By storing parameters corresponding to respective weights in advance in table form within the page table 220 and selecting one of the stored register tables based on each selected weight, the required area can be minimized compared to implementing the parameters as SFRs. Additionally, by storing multiple register tables in a compressed or encoded form, the required area can be further reduced. Accordingly, miniaturization of the electronic device including the ISP 200 can be achieved.

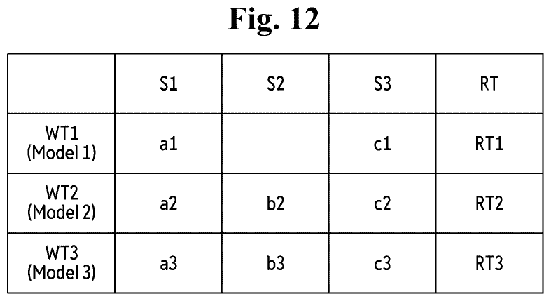

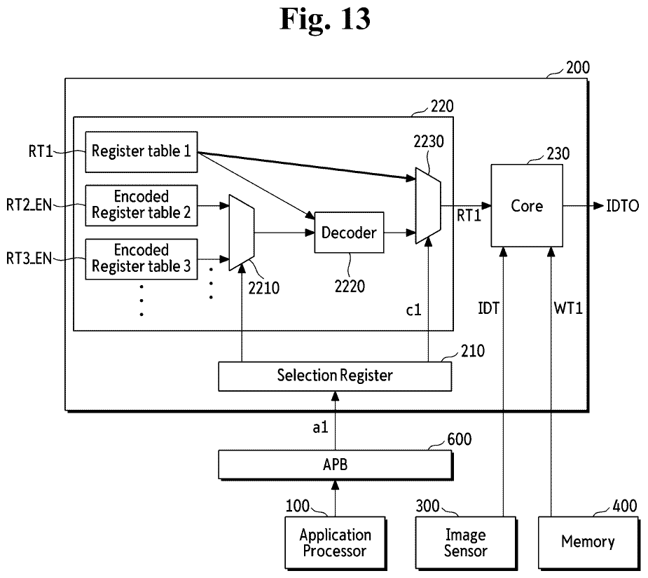

Referring to FIGS. 12 and 13, in some embodiments, as the application processor 100 selects a first training model Model1 that processes image data IDT using a first weight WT1, a first register table RT1 corresponding to the first weight WT1 may be selected within the ISP 200. Specifically, the application processor 100 may transmit a first control signal a1 to the selection register 210 to select the first register table RT1 corresponding to the first weight WT1 for use in the first training model Model1.

The selection register 210 may generate a first decoding signal c1 based on the first control signal a1 and may transmit the first decoding signal c1 to the page table 220.

As no control signal is provided to the first multiplexer 2210 included in the page table 220, the first multiplexer 2210 may not select either a second encoded register table RT2_EN or a third encoded register table RT3_EN. The second multiplexer 2230 included in the page table 220 may select the first register table RT1 based on the first decoding signal c1 and may transmit the first register table RT1 to the core 230.

The first register table RT1 may be a parameter corresponding to the first weight WT1. In some embodiments, the image data IDT may be provided from an image sensor 300. Under the command of the application processor 100, the first weight WT1 stored in the memory 400 may be provided to the core 230. The core 230 within the ISP 200 may process the image data IDT based on the first weight WT1 and the first register table RT1 corresponding to the first weight WT1. The image data IDT processed by the core 230, i.e., image data IDTO, may be provided to the application processor 100 (e.g., the main processor or graphics processor of the electronic device where the image sensor 300 is mounted).

By storing parameters corresponding to respective weights in advance in table form within the page table 220 and selecting one of the stored register tables based on each selected weight, the required area can be minimized compared to implementing the parameters as SFRs. Additionally, by storing multiple register tables in a compressed or encoded form, the required area can be further reduced. Accordingly, miniaturization of the electronic device including the ISP 200 can be achieved.

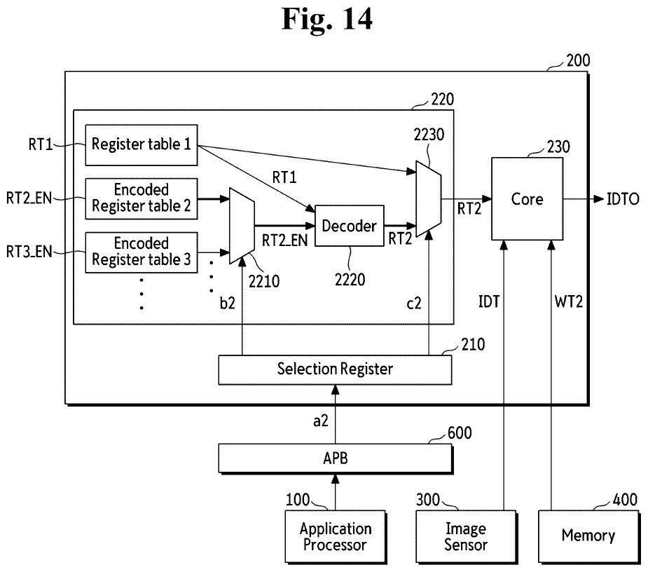

Referring to FIGS. 12 and 14, in some embodiments, as the application processor 100 selects a second training model Model2 that processes image data IDT using a second weight WT2, a second register table RT2 corresponding to the second weight WT2 may be selected within the ISP 200. Specifically, the application processor 100 may transmit a second control signal a2 to the selection register 210 to select the second register table RT2 corresponding to the second weight WT2 for use in the second training model Model2.

The selection register 210 may generate a second selection signal b2 and a second decoding signal c2 based on the second control signal a2, and may transmit the second selection signal b2 and the second decoding signal c2 to the page table 220.

The first multiplexer 2210 included in the page table 220 may select a second encoded register table RT2_EN based on the second selection signal b2 and may transmit the second encoded register table RT2_EN to the decoder 2220. The decoder 2220 may decode the second encoded register table RT2_EN output from the first multiplexer 2210 based on the first register table RT1, outputting the second register table RT2. The second multiplexer 2230 included in the page table 220 may select the second register table RT2 based on the second decoding signal c2 and may transmit the second register table RT2 to the core 230. The second register table RT2 may be a parameter corresponding to the second weight WT2.

In some embodiments, the image data IDT may be provided from the image sensor 300. Under the command of the application processor 100, the second weight WT2 stored in the memory 400 may be provided to the core 230. The core 230 within the ISP 200 may process the image data IDT based on the second weight WT2 and the second register table RT2 corresponding to the second weight WT2. The image data IDT processed by the core 230, i.e., image data IDTO, may be provided to the application processor 100 (e.g., the main processor or graphics processor of the electronic device where the image sensor 300 is mounted).

By storing parameters corresponding to respective weights in advance in table form within the page table 220 and selecting one of the stored register tables based on each selected weight, the required area can be minimized compared to implementing the parameters as SFRs. Additionally, by storing multiple register tables in a compressed or encoded form, the required area can be further reduced. Accordingly, miniaturization of the electronic device including the ISP 200 can be achieved.

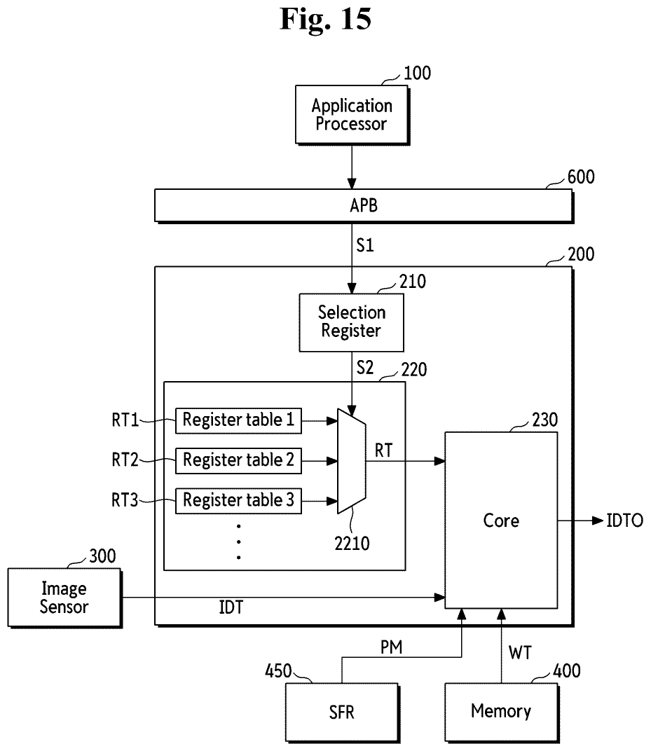

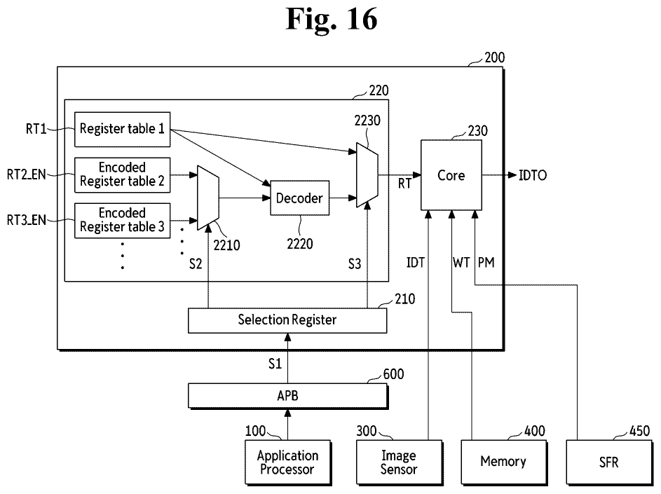

FIGS. 15 and 16 are block diagrams illustrating the configuration and operation of ISPs according to some embodiments of the present disclosure. FIG. 15 is similar to FIGS. 4 and 6, and the following description will focus on the differences between the embodiment of FIG. 15 and the embodiments of FIGS. 4 and 6. FIG. 16 is similar to FIGS. 4 and 11, and the following description will focus on the differences between the embodiment of FIG. 16 and the embodiments of FIGS. 4 and 11.

Referring to FIG. 15, an ISP 200 may process image data IDT based on a plurality of training models. The training models may process the image data IDT based on corresponding pairs of weights WT and parameters PM.

The parameters PM may be provided to a core 230 by an SFR 450 or may be stored in the form of first, second, and third register tables (RT1, RT2, and RT3, respectively) in a page table 220 and then provided to the core 230. The first, second, or third register tables (RT1, RT2, and RT3, respectively) may be tables storing the parameters PM as constant values applicable to the linear combinations of the respective weights WT and the image data IDT. The parameters PM may add nonlinearity to the linear combinations of the image data IDT and the weights WT.

In some embodiments, the core 230 within the ISP 200 may process the image data IDT based on a weight and a parameter PM corresponding to the weight WT. Here, the parameter PM may be provided to the core 230 by the SFR 450. In this case, a first signal S1 and a second signal S2 may not be generated by an application processor 100 and a selection register 210, respectively.

In some embodiments, the core 230 within the ISP 200 may process the image data IDT based on a weight WT and a register table RT corresponding to the weight WT. Here, the register table RT may be provided to the core 230 by the page table 220. In this case, based on a first signal S1 generated by the application processor 100 and a second signal S2 generated by the selection register 210, the page table 220 may provide the register table RT corresponding to the weight WT to the core 230.

By storing the parameters corresponding to the respective weights WT in advance in table form withing the page table 220 and selecting one of the stored register tables RT based on each selected weight WT, the total number of a special function register (SFR) can be effectively minimized compared to a approach in which SFR is assigned for each parameter. As a result, the number of register circuits can be reduced, and the complexity of the address decoding logic required for accessing the registers can also be lowered, thereby contributing to a reduction in the overall chip area of the image sensor system. Accordingly, miniaturization of the electronic device including the ISP 200 can be achieved.

Referring to FIG. 16, an ISP 200 may process image data IDT based on a plurality of training models. The training models may process the image data IDT based on corresponding pairs of weights WT and parameters PM.

The parameters PM may be provided to a core 230 by an SFR 450 or may be stored in the form of a first register table RT1, a second encoded register table RT2, and a third encoded register table RT3 within a page table 220 and then provided to the core 230. The first register table RT1, the second encoded register table RT2, and the third encoded register table RT3 may be tables storing the parameters PM as constant values applicable to the linear combinations of the weights WT and the image data IDT. The parameters PM may add nonlinearity to the linear combinations of the image data IDT and the weights WT.

In some embodiments, the core 230 within the ISP 200 may process the image data IDT based on a weight WT and a parameter PM corresponding to the weight WT. Here, the parameter PM may be provided to the core 230 by an SFR 450. In this case, a first signal S1 and a second signal S2 may not be generated by the application processor 100 and a selection register 210, respectively.

In some embodiments, the core 230 within the ISP 200 may process the image data IDT based on a weight WT and a register table RT corresponding to the weight WT. Here, the register table RT may be provided to the core 230 by the page table 220. In this case, based on a first signal S1 generated by the application processor 100 and a second signal S2 generated by the selection register 210, the page table 220 may provide the register table RT corresponding to the weight WT to the core 230.

By storing a portion of the parameters corresponding to the respective weights WT in advance in table form withing the page table 220 and selecting one of the stored register tables RT based on each selected weight WT, the total number of a special function register (SFR) can be effectively minimized compared to a approach in which SFR is assigned for each parameter. As a result, the number of register circuits can be reduced, and the complexity of the address decoding logic required for accessing the registers can also be lowered, thereby contributing to a reduction in the overall chip area of the image sensor system. Accordingly, miniaturization of the electronic device including the ISP 200 can be achieved.

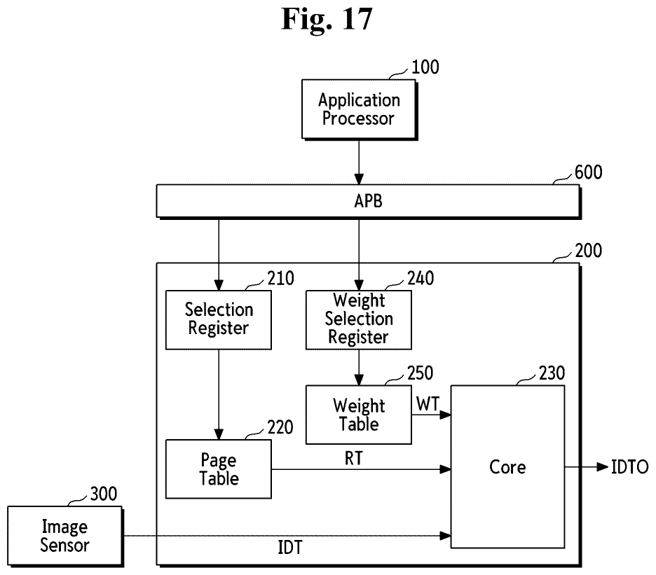

FIGS. 17 through 22 are diagrams illustrating the configuration and operation of an ISP according to some embodiments of the present disclosure.

Referring to FIG. 17, an ISP 200 may include a plurality of image signal processing logics. For convenience of explanation, only one image signal processing logic is illustrated as being included in the ISP 200. The ISP 200 may include a selection register 210, a page table 220, a core 230, a weight selection register 240, and a weight table 250, and the selection register 210, the page table 220, the core 230, the weight selection register 240, and the weight table 250 may constitute deep learning-based processing logic.

The ISP 200 may process image data IDT based on a plurality of training models. Each of the training models may process image data IDT based on corresponding pairs of weights WT and register tables RT.

The weights WT may be stored in the weight table 250. The weight table 250 may select one of the weights WT stored therein and transmit the selected weight WT to the core 230 based on a signal provided by the weight selection register 240. The weights WT may adjust the importance of the image data IDT when the image data IDT is transmitted to each neuron in a neural network. For example, the weights WT may each form a linear combination with the image data IDT for each neuron.

The register tables RT may be stored in the page table 220. One of the register tables RT stored in the page table 220 may be selected based on a signal transmitted from the selection register 210 and then transmitted to the core 230. The register tables RT may be tables storing parameters applicable to the linear combinations of the weights WT and the image data IDT as constant values. In some embodiments, the parameters may add nonlinearity to the linear combinations of an input value and the weights WT.

The image data IDT may be provided to the core 230 from an image sensor 300. Under the command of the application processor 100, one of the weights WT stored in the weight table 250 may be provided to the core 230. Under the command of the application processor 100, one of the register tables RT stored in the page table 220 may be provided to the core 230. The core 230 within the ISP 200 may process the image data IDT based on the weight WT provided thereto and the corresponding register table RT. The image data IDT processed by a core 230, i.e., image data IDTO, may be provided to the application processor 100 (e.g., the main processor or graphics processor of an electronic device where the image sensor 300 is mounted).

By storing parameters corresponding to the respective weights in advance in table form within a page table 220 and selecting one of the stored register tables based on each selected weight, the required area can be minimized compared to implementing the parameters as SFRs. Accordingly, miniaturization of the electronic device including the ISP 200 can be achieved.

The core 230 within the ISP 200 may process the image data IDT based on the weights WT and the corresponding register tables RT. The image data IDT processed by the core 230, i.e., image data IDTO, may be provided to the application processor 100 (e.g., the main processor or graphics processor of the electronic device where the image sensor 300 is mounted).

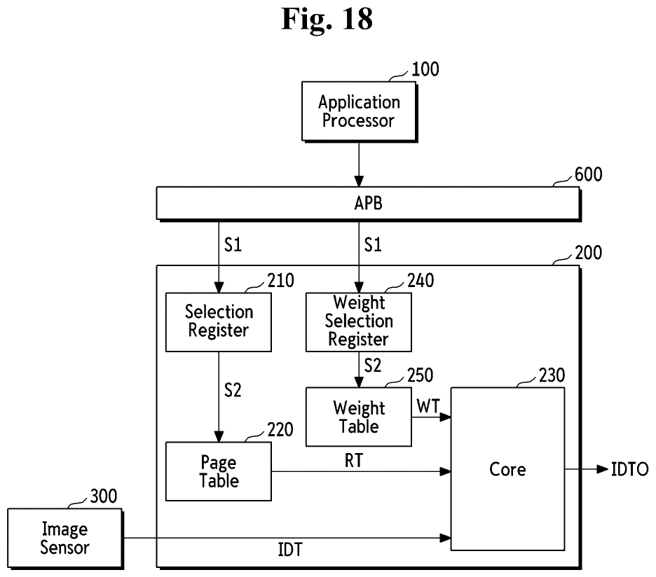

Referring to FIG. 18, the image data IDT, the weights WT, and the register tables RT may be provided to the core 230.

In some embodiments, the image data IDT may be provided from the image sensor 300. The application processor 100 may select a training model to be used for processing the image data IDT and may transmit a first signal S1 to the selection register 210 and the weight selection register 240. The first signal S1 may be a signal generated based on the selected training model to be used by the ISP 200.

The selection register 210 may generate a second signal S2 based on the first signal S1 and may transmit the second signal S2 to the page table 220. The page table 220 may select one of the register tables RT stored therein based on the second signal S2 and transmit the selected register table RT to the core 230. The weight selection register 240 may generate the second signal S2 based on the first signal S1 and transmit the second signal S2 to the weight table 250. The weight table 250 may select one of the weights WT stored therein based on the second signal S2 and transmit the selected weight WT to the core 230.

The core 230 may process the image data IDT using the weight WT and register table RT provided thereto. As the weight WT and register table RT provided to the core 230 are based on the same second signal S2, they may correspond to each other. The image data IDT processed by the core 230, i.e., image data IDTO, may be provided to the application processor 100 (e.g., the main processor or graphics processor of an electronic device where the image sensor 300 is mounted).

By storing the parameters corresponding to the respective weights WT in advance in table form withing the page table 220 and selecting one of the stored register tables RT based on each selected weight WT, the total number of a special function register (SFR) can be effectively minimized compared to a approach in which SFR is assigned for each parameter. As a result, the number of register circuits can be reduced, and the complexity of the address decoding logic required for accessing the registers can also be lowered, thereby contributing to a reduction in the overall chip area of the image sensor chip. Accordingly, miniaturization of an electronic device including the ISP 200 can be achieved.

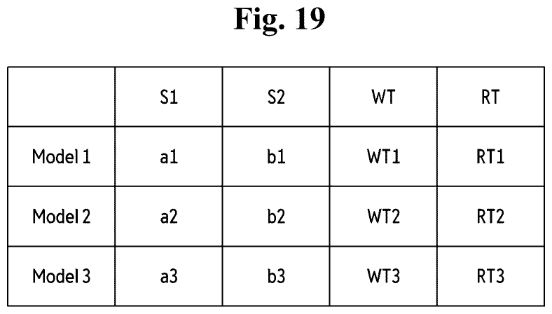

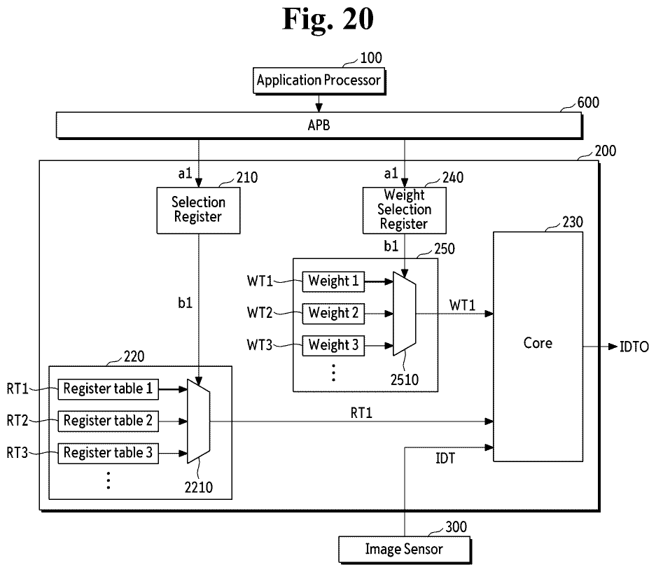

Referring to FIGS. 19 and 20, as the application processor 100 selects a first training model Model1 that processes image data IDT using a first weight WT1, the first weight WT1 and a first register table RT1 corresponding to the first weight WT1 may be selected within the ISP 200. Specifically, the application processor 100 may transmit a first control signal a1 to the weight selection register 240 and the selection register 210 to select the first weight WT1 and the first register table RT1 corresponding to the first weight WT1 for use in the first training model Model1. The selection register 210 may generate a first selection signal b1 based on the first control signal a1 and transmit the first selection signal b1 to the page table 220.

The page table 220 may include a plurality of register tables RT and a first multiplexer 2210. Each of the plurality of register tables RT may be an input signal for the first multiplexer 2210, and the first selection signal b1 may be a control signal for the first multiplexer 2210. The first multiplexer 2210 may select the first register table RT1 corresponding to the first selection signal b1 from among the plurality of register tables RT and transmit the first register table RT1 to the core 230.

The weight selection register 240 may generate the first selection signal b1 based on the first control signal a1 and transmit the first selection signal b1 to the weight table 250. The weight table 250 may include a plurality of weights WT and a third multiplexer 2510. Each of the plurality of weights WT may be an input signal for the third multiplexer 2510, and the first selection signal b1 may be a control signal for the third multiplexer 2510. The third multiplexer 2510 may select the first weight WT1 corresponding to the first selection signal b1 from among the plurality of weights WT and transmit the first weight WT1 to the core 230.

The image data IDT may be provided from an image sensor 300. The core 230 may process the image data IDT based on the first weight WT1 and the first register table RT1 corresponding to the first weight WT1. The image data IDT processed by the core 230, i.e., image data IDTO, may be provided to the application processor 100 (e.g., the main processor or graphics processor of an electronic device where the image sensor 300 is mounted).

By storing parameters corresponding to respective weights in advance in table form within the page table 220 and selecting one of the stored register tables based on each selected weight, the required area can be minimized compared to implementing the parameters as SFRs. Accordingly, miniaturization of an electronic device including the ISP 200 can be achieved.

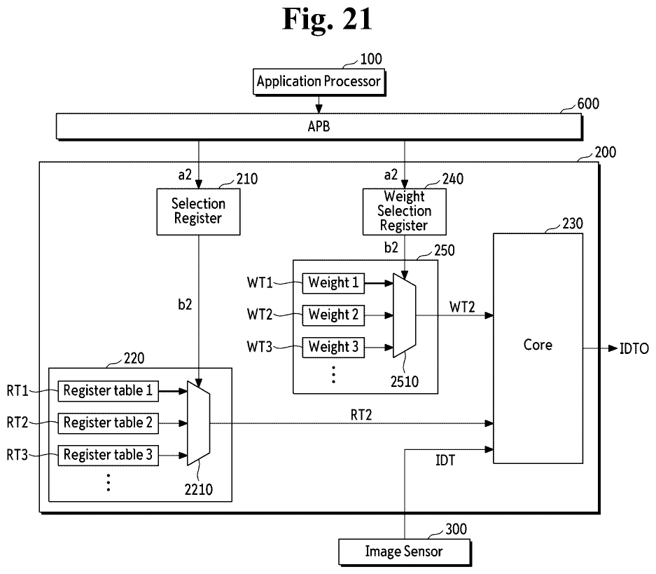

Referring to FIGS. 19 and 21, as the application processor 100 selects a second training model Model2 that processes image data IDT using a second weight WT2, the second weight WT2 and a second register table RT2 corresponding to the second weight WT2 may be selected within the ISP 200.

Specifically, the application processor 100 may transmit a second control signal a2 to the weight selection register 240 and the selection register 210 to select the second weight WT2 and the second register table RT2 corresponding to the second weight WT2 for use in the second training model Model2. The selection register 210 may generate a second selection signal b2 based on the second control signal a2 and transmit the second selection signal b2 to the page table 220.

The first multiplexer 2210 included in the page table 220 may select the second register table RT2 corresponding to the second selection signal b2 from among a plurality of register tables RT based on the second selection signal b2 and may transmit the second register table RT2 to the core 230. The weight selection register 240 may generate the second selection signal b2 based on the second control signal a2 and transmit the second selection signal b2 to the weight table 250.

The third multiplexer 2510 included in the weight table 250 may select the second weight WT2 corresponding to the second selection signal b2 from among a plurality of weights WT based on the second selection signal b2 and may transmit the second weight WT2 to the core 230. The image data IDT may be provided from the image sensor 300. The core 230 may process the image data IDT based on the second weight WT2 and the second register table RT2 corresponding to the second weight WT2. The image data IDT processed by the core 230, i.e., image data IDTO, may be provided to the application processor 100 (e.g., the main processor or graphics processor of an electronic device where the image sensor 300 is mounted).

By storing parameters corresponding to respective weights in advance in table form within a page table 220 and selecting one of the stored register tables based on each selected weight, the required area can be minimized compared to implementing the parameters as SFRs. Accordingly, miniaturization of an electronic device including the ISP 200 can be achieved.

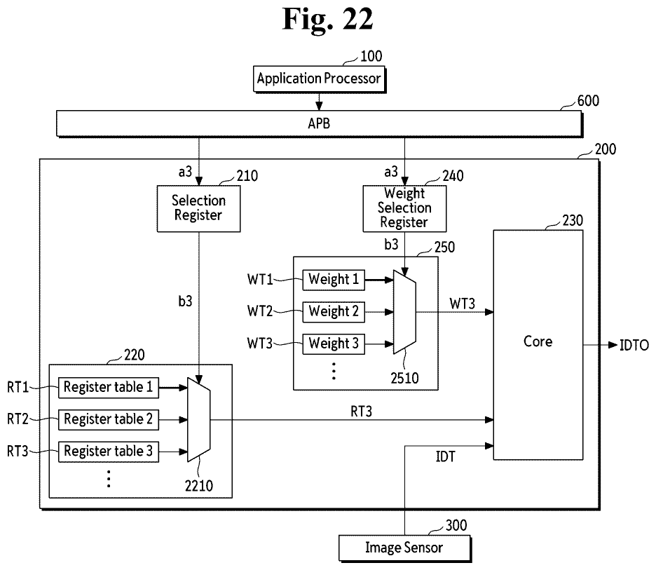

Referring to FIGS. 19 and 22, as the application processor 100 selects a third training model Model3 that processes image data IDT using a third weight WT3, the third weight WT3 and a third register table RT3 corresponding to the third weight WT3 may be selected within the ISP 200. Specifically, the application processor 100 may transmit a third control signal a3 to the weight selection register 240 and the selection register 210 to select the third weight WT3 and the third register table RT3 corresponding to the third weight WT3 for use in the third training model Model3.

The selection register 210 may generate a third selection signal b3 based on the third control signal a3 and transmit the third selection signal b3 to the page table 220. The first multiplexer 2210 included in the page table 220 may select the third register table RT3 corresponding to the third selection signal b3 from among a plurality of register tables RT based on the third selection signal b3 and may transmit the third register table RT3 to the core 230.

The weight selection register 240 may generate the third selection signal b3 based on the third control signal a3 and transmit the third selection signal b3 to the weight table 250. The third multiplexer 2510 included in the weight table 250 may select the third weight WT3 corresponding to the third selection signal b3 from among a plurality of weights WT based on the third selection signal b3 and may transmit the third weight WT3 to the core 230.

The image data IDT may be provided from the image sensor 300. The core 230 may process the image data IDT based on the third weight WT3 and the third register table RT3 corresponding to the third weight WT3. The image data IDT processed by the core 230, i.e., image data IDTO, may be provided to the application processor 100 (e.g., the main processor or graphics processor of an electronic device where the image sensor 300 is mounted).

By storing parameters corresponding to respective weights in advance in table form within the page table 220 and selecting one of the stored register tables based on each selected weight, the required area can be minimized compared to implementing the parameters as SFRs. Accordingly, miniaturization of an electronic device including the ISP 200 can be achieved.

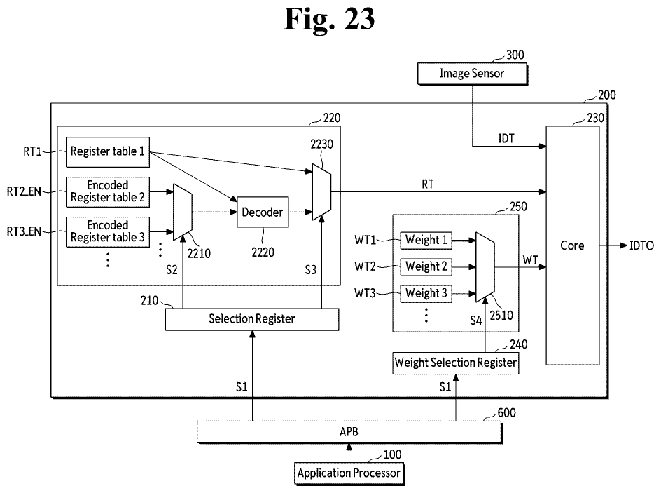

FIGS. 23 through 25 are block diagrams illustrating the configuration and operation of an ISP according to some embodiments of the present disclosure.

Referring to FIG. 23, in some embodiments, an application processor 100 may select a training model to be used for processing image data IDT and transmit a first signal S1 to a selection register 210 and a weight selection register 240. The first signal S1 may be a signal generated based on the training model to be used by an ISP 200. The selection register 210 may generate a second signal S2 and a third signal S3 based on the first signal S1 and may transmit the second signal S2 and the third signal S3 to a page table 220.

The page table 220 may include a plurality of register tables RT, a first multiplexer 2210, a decoder 2220, and a second multiplexer 2230. The plurality of register tables RT may include a first register table RT1, a second encoded register table RT2_EN, and a third encoded register table RT3_EN. The first register table RT1 may be a parameter corresponding to a first weight WT1. The second encoded register table RT2_EN may be an encoded form of a second register table RT2 corresponding to a second weight WT2, which is different from the first weight WTI1. The second encoded register table RT2_EN may store the difference values between the first and second register tables RT1 and RT2 in table form. The third encoded register table RT3_EN may be an encoded form of a third register table RT3 corresponding to a third weight WT3, which is different from the first and second weights WT1 and WT2. The third encoded register table RT3_EN may store the difference values between the first and third register tables RT1 and RT3 in table form. The second and third encoded register tables RT2_EN and RT3_EN may be input signals for the first multiplexer 2210, and the second signal S2 may be a control signal for the first multiplexer 2210. The first multiplexer 2210 may select one of the second and third encoded register tables RT2_EN and RT3_EN corresponding to the second signal S2 and may transmit the selected encoded register table RT2_EN or RT3_EN to the decoder 2220.

The decoder 2220 may decode the encoded register table RT2_EN or RT3_EN output from the first multiplexer 2210 based on the first register table RT1, outputting either the second register table RT2 or the third register table RT3. For example, if the second encoded register table RT2_EN is selected by the second signal S2 in the first multiplexer 2210, the decoder 2220 may output the second register table RT2 based on the first register table RT1 and the second encoded register table RT2_EN. Additionally, if the third encoded register table RT3_EN is selected by the second signal S2 in the first multiplexer 2210, the decoder 2220 may output the third register table RT3 based on the first register table RT1 and the third encoded register table RT3_EN. The second register table RT2 or the third register table RT3 output from the decoder 2220 may be transmitted to the second multiplexer 2230.

The second multiplexer 2230 may transmit either the first register table RT1 or the output signal from the decoder 2220 to the core 230 based on the third signal S3. The output signal of the second multiplexer 2230 may be one of the first, second, and third register tables RT1, RT2, and RT3 corresponding to the selected weight WT.

The weight selection register 240 may generate a fourth signal S4 based on the first signal S1 and transmit the fourth signal S4 to a weight table 250. The weight table 250 may include a plurality of weights WT and a third multiplexer 2510. Each of the plurality of weights WT may be an input signal for the third multiplexer 2510, and the fourth signal S4 may be a control signal for the third multiplexer 2510. The third multiplexer 2510 may select the weight WT corresponding to the fourth signal S4 and transmit the selected weight WT to the core 230.

The image data IDT may be provided to the core 230 from an image sensor 300. The core 230 within the ISP 200 may process the image data IDT based on the selected weight WT and the selected register table RT corresponding to the selected weight WT. The image data IDT processed by the core 230, i.e., image data IDTO, may be provided to the application processor 100 (e.g., the main processor or graphics processor of the electronic device where the image sensor 300 is mounted).

By storing parameters corresponding to respective weights in advance in table form within the page table 220 and selecting one of the stored register tables based on each selected weight, the required area can be minimized compared to implementing the parameters as SFRs. Additionally, by storing multiple register tables in a compressed or encoded form, the required area can be further reduced. Accordingly, miniaturization of the electronic device including the ISP 200 can be achieved.

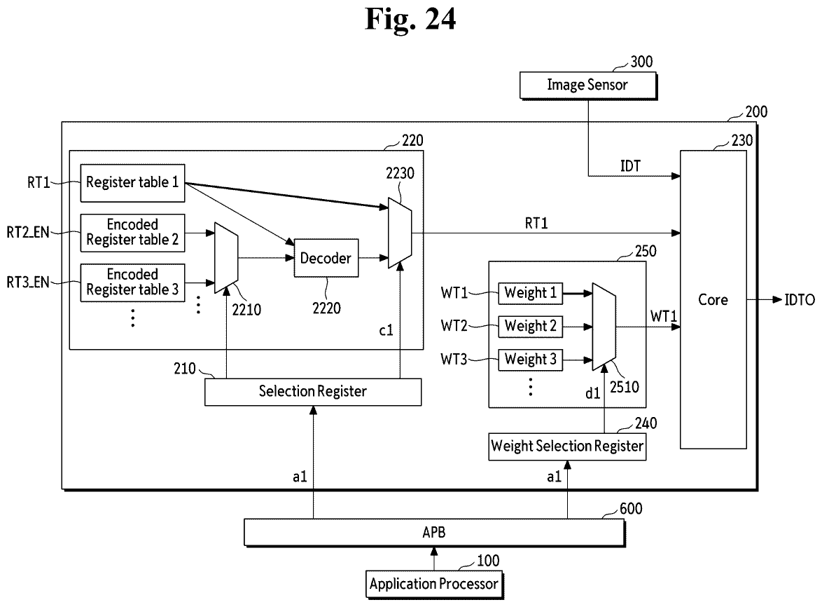

Referring to FIG. 24, in some embodiments, as the application processor 100 selects a first training model Model1 to be used by the ISP 200, a first weight WT1 and a first register table RT1 corresponding to the first training model Model1 may be selected within the ISP 200.

The application processor 100 may select the first training model Model1 to be used for processing image data IDT and transmit a first control signal a1 to the selection register 210 and the weight selection register 240. The first control signal a1 may be a signal generated based on the first training model Model1 to be used by the ISP 200. The selection register 210 may generate a first decoding signal c1 based on the first control signal a1 and may transmit the first decoding signal c1 to the page table 220.

As no control signal is provided to the first multiplexer 2210 included in the page table 220, the first multiplexer 2210 may not select either the second encoded register table RT2_EN or the third encoded register table RT3_EN. The second multiplexer 2230 included in the page table 220 may select the first register table RT1 based on the first decoding signal c1 and may transmit the first register table RT1 to a core 230.

The weight selection register 240 may generate a first weights selection signal d1 based on the first control signal a1 and transmit the first weights selection signal d1 to the weight table 250. The weight table 250 may include the plurality of weights WT and the third multiplexer 2510. Each of the plurality of weights WT may be an input signal for the third multiplexer 2510, and the first weights selection signal d1 may be a control signal for the third multiplexer 2510. The third multiplexer 2510 may select the first weight WT1 corresponding to the first weights selection signal d1 and transmit the first weight WT1 to the core 230.

The image data IDT may be provided from the image sensor 300. The core 230 within the ISP 200 may process the image data IDT based on the first weight WT1 and the first register table RT1 corresponding to the first weight WT1. The image data IDT processed by the core 230, i.e., image data IDTO, may be provided to the application processor 100 (e.g., the main processor or graphics processor of the electronic device where the image sensor 300 is mounted).

By storing parameters corresponding to respective weights in advance in table form within the page table 220 and selecting one of the stored register tables based on each selected weight, the required area can be minimized compared to implementing the parameters as SFRs. Additionally, by storing multiple register tables in a compressed or encoded form, the required area can be further reduced. Accordingly, miniaturization of the electronic device including the ISP 200 can be achieved.

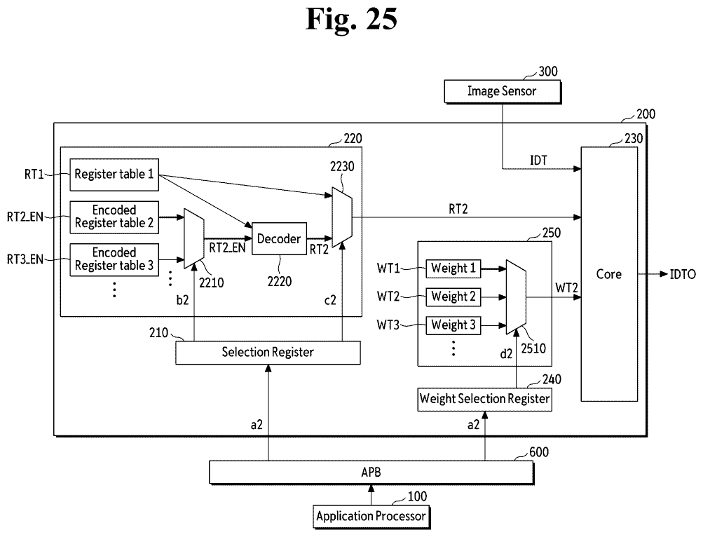

Referring to FIG. 25, in some embodiments, as the application processor 100 selects a second training model Model2 to be used by the ISP 200, a second weight WT2 and a second register table RT2 corresponding to the second weight WT2 may be selected within the ISP 200. Specifically, the application processor 100 may select the second training model Model2 to be used for processing image data IDT and transmit a second control signal a2 to the selection register 210 and the weight selection register 240. The second control signal a2 may be a signal generated based on the second training model Model2 to be used by the ISP 200.

The selection register 210 may generate a second selection signal b2 and a second decoding signal c2 based on the second control signal a2 and may transmit the second selection signal b2 and the second decoding signal c2 to the page table 220. The first multiplexer 2210 included in the page table 220 may select the second encoded register table RT2_EN based on the second selection signal b2 and may transmit the second encoded register table RT2_EN to the decoder 2220. The decoder 2220 may decode the second encoded register table RT2_EN output from the first multiplexer 2210 based on the first register table RT1, outputting the second register table RT2.

The second multiplexer 2230 included in the page table 220 may select the second register table RT2 based on the second decoding signal c2 and may transmit the second register table RT2 to the core 230. The second register table RT2 may be a parameter corresponding to the second weight WT2.

The weight selection register 240 may generate a second weights selection signal d2 based on the second control signal a2 and transmit the second weights selection signal d2 to the weight table 250. The weight table 250 may include the plurality of weights WT and the third multiplexer 2510. Each of the plurality of weights WT may be an input signal for the third multiplexer 2510, and the second weights selection signal d2 may be a control signal for the third multiplexer 2510. The third multiplexer 2510 may select the second weight WT2 corresponding to the second weights selection signal d2 and transmit the second weight WT2 to the core 230.

The image data IDT may be provided from the image sensor 300. The core 230 within the ISP 200 may process the image data IDT based on the second weight WT2 and the second register table RT2 corresponding to the second weight WT2. The image data IDT processed by the core 230, i.e., image data IDTO, may be provided to the application processor 100 (e.g., the main processor or graphics processor of the electronic device where the image sensor 300 is mounted).

By storing parameters corresponding to respective weights in advance in table form within the page table 220 and selecting one of the stored register tables based on each selected weight, the required area can be minimized compared to implementing the parameters as SFRs. Additionally, by storing multiple register tables in a compressed or encoded form, the required area can be further reduced. Additionally, by storing multiple register tables in a compressed or encoded form, the required area can be further reduced. Accordingly, miniaturization of the electronic device including the ISP 200 can be achieved.

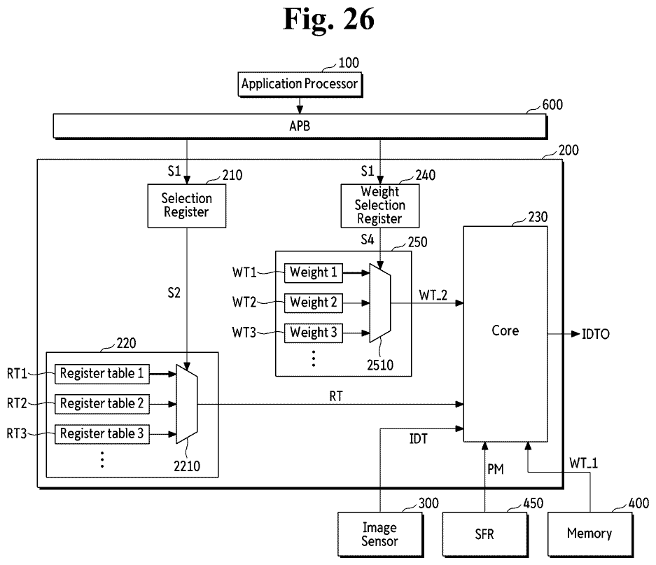

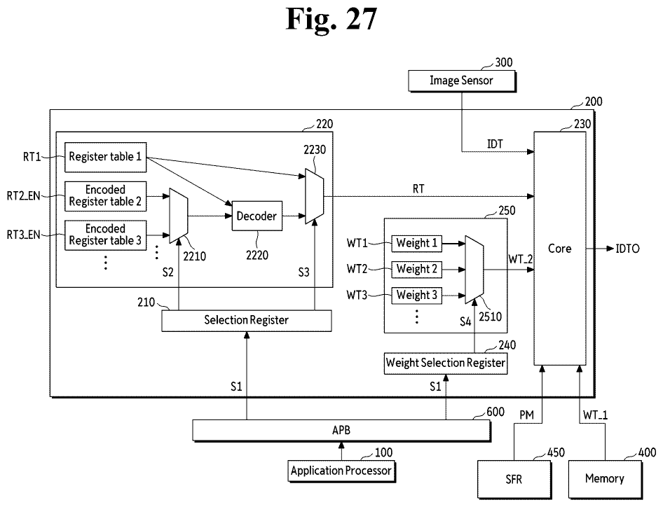

FIGS. 26 and 27 are block diagrams illustrating the configuration and operation of ISPs according to some embodiments of the present disclosure. FIG. 26 is similar to FIGS. 17 and 18, and the following description will focus on the differences between the embodiment of FIG. 26 and the embodiment of FIGS. 17 and 18. FIG. 16 is similar to FIGS. 17 and 23, and the following description will focus on the differences between the embodiment of FIG. 27 and the embodiments of FIGS. 17 and 23.

Referring to FIG. 26, an ISP 200 may process image data IDT based on a plurality of training models. Each of the training models may process the image data IDT based on corresponding pairs of weights (WT_1 and WT_2) and parameters PM.

Some weights WT_1 may be provided to a core 230 by a memory 400. Other weights WT_2 may be stored in a weight table 250 and provided to the core 230. The weight table 250 may select one of the weights WT_2 stored therein based on a fourth signal S4 transmitted from a weight selection register 240 and transmit the selected weight WT_2 to the core 230.

Some parameters PM may be provided to the core 230 by an SFR 450. Other parameters PM may be stored in the form of first, second, and third register tables RT1, RT2, and RT3 within a page table 220 and provided to the core 230. The first, second, and third register tables RT1, RT2, and RT3 may be tables storing the parameters PM as constant values applicable to the linear combinations of the weights (WT_1 and WT_2) and the image data IDT. The parameters PM may add nonlinearity to the linear combinations of the image data IDT and the weights (WT_1 and WT_2).

In some embodiments, the core 230 within the ISP 200 may process the image data IDT based on a weight WT_1 and a corresponding parameter PM provided from the memory 400. Here, the parameter PM may be provided to the core 230 by the SFR 450. In this case, a first signal S1, a second signal S2, and a fourth signal S4 may not be generated by an application processor 100, a selection register 210, and a weight selection register 240, respectively.

In some embodiments, the core 230 within the ISP 200 may process the image data IDT based on a weight WT_1 and a corresponding register table RT provided from the memory 400. One of the first, second, and third register tables RT1, RT2, and RT3 may be provided to the core 230 by the page table 220. In this case, based on a first signal S1 generated by the application processor 100 and a second signal S2 generated by the selection register 210, the page table 220 may provide the register table RT corresponding to the weight WT_1 to the core 230. However, the weight selection register 240 may not generate a fourth signal S4.

In some embodiments, the core 230 within the ISP 200 may process the image data IDT based on a weight WT_2 and a corresponding parameter PM provided from the weight table 250. Here, the parameter PM may be provided to the core 230 by the SFR 450. In this case, a second signal S2 may not be generated by the selection register 210.

In some embodiments, the core 230 within the ISP 200 may process the image data IDT based on a weight WT_2 and a corresponding register table RT provided from the memory 400. One of the first, second, and third register tables RT1, RT2, and RT3 may be provided to the core 230 by the page table 220. In this case, a first signal S1, a second signal S2, and a fourth signal S4 may all be generated by the application processor 100, the selection register 210, and the weight selection register 210, respectively.

Referring to FIG. 27, an ISP 200 may process image data IDT based on a plurality of training models. The training models may process the image data IDT based on corresponding pairs of weights WT and parameters PM.

Some weights WT_1 may be provided to a core 230 by a memory 400. Other weights WT_2 may be stored in a weight table 250 and provided to the core 230. The weight table 250 may select one of the weights WT_2 stored therein based on a fourth signal S4 transmitted from a weight selection register 240 and transmit the selected weight WT_2 to the core 230.

Some parameters PM may be provided to the core 230 by an SFR 450. Other parameters PM may be stored in the form of a first register table RT1, a second encoded register table RT2_EN, and a third encoded register table RT3_EN within a page table 220 and provided to the core 230. The first, second, and third register tables RT1, RT2_EN, and RT3_EN may be tables storing the parameters PM as constant values applicable to the linear combinations of the weights (WT_1 and WT_2) and the image data IDT. The parameters PM may add nonlinearity to the linear combinations of the image data IDT and the weights (WI_1 and WT_2).

In some embodiments, the core 230 within the ISP 200 may process the image data IDT based on a weight WT_1 and a corresponding parameter PM provided from the memory 400. Here, the parameter PM may be provided to the core 230 by the SFR 450. In this case, a first signal S1, a second signal S2, and a fourth signal S4 may not be generated by an application processor 100, a selection register 210, and a weight selection register 240, respectively.

In some embodiments, the core 230 within the ISP 200 may process the image data IDT based on a weight WT_1 and a corresponding register table RT provided from the memory 400. Here, the register table RT may be provided to the core 230 by the page table 220. In this case, based on a first signal S1 generated by the application processor 100 and a second signal S2 generated by the selection register 210, the page table 220 may provide the register table RT corresponding to the weight WT_1 to the core 230. However, the weight selection register 210 may not generate a fourth signal S4.

In some embodiments, the core 230 within the ISP 200 may process the image data IDT based on a weight WT_2 and a corresponding parameter PM provided from the weight table 250. Here, the parameter PM may be provided to the core 230 by the SFR 450. In this case, a second signal S2 may not be generated by the selection register 210.

In some embodiments, the core 230 within the ISP 200 may process the image data IDT based on a weight WT_2 and a corresponding register table RT provided from the memory 400. Here, the register table RT may be provided to the core 230 by the page table 220. In this case, a first signal S1, a second signal S2, and a fourth signal S4 may all be generated by the application processor 100, the selection register 210, and the weight selection register 210, respectively.

Although embodiments of the present disclosure have been described with reference to the accompanying drawings, the present disclosure is not limited to the described embodiments and may be embodied in various other forms. Those skilled in the art will appreciate that various modifications, combinations, and changes can be made without departing from the spirit and scope of the disclosure. Therefore, the embodiments described herein should be considered illustrative and not restrictive in any sense.

What is claimed is:

1. An image sensor system comprising:
an image sensor including a pixel array converting a received optical signal into an electrical signal and a readout circuit that converts the electrical signal into image data and outputs the image data;
a memory storing a plurality of weights used for processing the image data;
a processor selecting one of the plurality of weights and providing a control signal generated by the selected weight to an image signal processor (ISP); and
the ISP which includes:
a page table including a plurality of register tables used for processing the image data;
a selection register outputting a second signal that selects a register table corresponding to the selected weight from among the plurality of register tables, in response to the control signal; and
a core processing the image data based on the selected weight and the register table corresponding to the selected weight.

2. The image sensor system of claim 1, wherein
the memory includes a first weight and a second weight different from the first weight, and
the page table includes a first register table corresponding to the first weight and a second register table corresponding to the second weight.

3. The image sensor system of claim 2, wherein the page table includes a multiplexer that selects and outputs one of the plurality of register tables in response to the second signal.

4. The image sensor system of claim 3, wherein
the processor selects the first weight and provides a first control signal generated by the first weight to the ISP,
the selection register outputs a first selection signal corresponding to the first register table in response to the first control signal, and
the multiplexer outputs the first register table in response to the first selection signal.

5. The image sensor system of claim 2, wherein the core receives the first weight from the memory, receives the first register table from the page table, performs a first operation of calculating a weighted sum of the image data based on the first weight, and performs a second operation of adding nonlinearity to the weighted sum based on the first register table.

6. The image sensor system of claim 1, wherein
the memory includes a first weight, a second weight different from the first weight, and a third weight different from the first and second weights,
the plurality of register tables include a first register table corresponding to the first weight, a second encoded register table corresponding to the second weight, and a third encoded register table corresponding to the third weight,
the second encoded register table stores difference values between the first register table and a second register table corresponding to the second weight, and
the third encoded register table stores difference values between the first register table and a third register table corresponding to the third weight.

7. The image sensor system of claim 6, wherein
in response to the control signal, the selection register further outputs a third signal selecting a register table corresponding to the selected weight from among the plurality of register tables, and
the page table includes: a first multiplexer selecting and outputting one of the second and third encoded register tables in response to the second signal; a decoder generating and outputting the second register table or the third register table from an output signal of the first multiplexer and the first register table; and a second multiplexer selecting and outputting one of an output signal of the decoder and the first register table in response to the third signal.

8. The image sensor system of claim 7, wherein in response to the processor providing a first control signal generated by the first weight to the ISP, the selection register outputs a first decoding signal corresponding to the first register table, and the second multiplexer outputs the first register table in response to the first decoding signal.

9. The image sensor system of claim 7, wherein in response to the processor providing a second control signal generated by the second weight to the ISP, the selection register outputs a second selection signal and a second decoding signal corresponding to the second register table, the first multiplexer outputs the second encoded register table in response to the second selection signal, the decoder generates and outputs the second register table from the second encoded register table and the first register table, and the second multiplexer outputs the second register table in response to the second decoding signal.

10. The image sensor system of claim 9, wherein
the core receives the second weight from the memory, receives the second register table from the page table, performs a first operation of calculating a weighted sum of the image data based on the second weight, and performs a second operation of adding nonlinearity to the weighted sum based on the second register table.

11. The image sensor system according to claim 1, wherein the ISP includes a deep learning bad pixel corrector (DLBPC).

12. An image sensor system comprising:
An image sensor including a pixel array converting a received optical signal into an electrical signal and a readout circuit that converts the electrical signal into image data and outputs the image data;
a processor selecting a training model to be used for processing the image data and providing a control signal generated by the selected training model to an image signal processor (ISP);
a selection register outputting a second signal that controls the selection of a register table corresponding to the selected training model, in response to the control signal;
a weight selection register outputting a fourth signal that controls the selection of a weight corresponding to the selected training model, in response to the control signal;
a page table storing a plurality of register tables and selecting and outputting one of the plurality of register tables based on the second signal;
a weight table storing a plurality of weights and selecting and outputting one of the plurality of weights based on the fourth signal; and
the ISP including a core that processes the image data based on the selected weight and the register table corresponding to the selected weight.

13. The image sensor system of claim 12, wherein
the weight table includes a first weight and a second weight different from the first weight, and
the page table includes a first register table corresponding to the first weight and a second register table corresponding to the second weight.

14. The image sensor system of claim 13, wherein
the page table includes a first multiplexer that selects and outputs one of the plurality of register tables in response to the second signal, and
the weight table includes a second multiplexer that selects and outputs one of the plurality of weights in response to the fourth signal.

15. The image sensor system of claim 13, wherein
the processor selects the first training model and provides a first control signal generated by the first training model to the ISP,
the selection register outputs a first selection signal corresponding to the first register table in response to the first control signal,
the weight selection register outputs a first weights selection signal corresponding to the first weight in response to the first control signal,
the weight table outputs the first weight in response to the first weights selection signal, and
the page table outputs the first register table in response to the first selection signal.

16. The image sensor system of claim 15, wherein the core receives the first weight from the weight table, receives the first register table from the page table, performs a first operation of calculating a weighted sum of the image data based on the first weight, and performs a second operation of adding nonlinearity to the weighted sum based on the first register table.

17. The image sensor system of claim 12, wherein
the weight table includes a first weight, a second weight different from the first weight, and a third weight different from both the first and second weights,
the plurality of register tables includes: a first register table corresponding to the first weight, a second encoded register table corresponding to the second weight, and a third encoded register table corresponding to the third weight,
the second encoded register table stores difference values between the first register table and a second register table corresponding to the second weight, and
the third encoded register table stores difference values between the first register table and a third register table corresponding to the third weight.

18. The image sensor system of claim 17, wherein
the selection register further outputs a third signal that selects a register table corresponding to the selected training model from among the plurality of register tables, in response to the control signal, and
the page table includes: a first multiplexer selecting and outputting one of the second and third encoded register tables in response to the second signal; a decoder generating and outputting the second or third register table from the output of the first multiplexer and the first register table; and a second multiplexer selecting and outputting one of an output signal of the decoder and the first register table in response to the third signal.

19. The image sensor system of claim 18, wherein the weight table includes a third multiplexer that selects and outputs one of the plurality of weights in response to the fourth signal.

20. An image sensor system comprising:
an image sensor including a pixel array converting a received optical signal into an electrical signal and a readout circuit that converts the electrical signal into image data and outputs the image data;
a memory storing a plurality of weights used for processing the image data;
a processor selecting a first weight from among the plurality of weights and providing a first control signal generated by the first weight to an image signal processor (ISP);
a page table including a plurality of register tables used for processing the image data;
a selection register outputting a first selection signal that selects a first register table corresponding to the first weight from among the plurality of register tables, in response to the first control signal; and
an image signal processor (ISP) including a core that processes the image data based on the first weight received from the memory and the first register table received from the page table,
wherein
the page table includes a multiplexer that selects and outputs the first register table from among the plurality of register tables in response to the first selection signal, and
the core performs a first operation of calculating a weighted sum of the image data based on the first weight, and performs a second operation of adding nonlinearity to the weighted sum based on the first register table.
